(19) United States
(12) Patent Application Publication
(10) Pub. No.: US 2026/0213696 A1
(43) Pub. Date: Jul. 23, 2026

(54) Floating Solar Energy Production Device

(71) Applicant: Geir Kroken, Nordfjordeid (NO)

(72) Inventors: Geir Kroken, Nordfjordeid (NO); Elias Kroken, Nordfjordeid (NO)

(21) Appl. No.: 19/138,158

(22) PCT Filed: Dec. 11, 2023
(86) PCT No.: PCT/NO2023/060120

§ 371 Date: Jun. 12, 2025

(30) Foreign Application Priority Data
Dec. 12, 2022 (NO) 20221329

(51) Int. Cl. H02S 20/00

(52) U.S. Cl. CPC H02S 20/00

(57) ABSTRACT

Floating device for solar energy production comprising a plurality of connected solar panels arranged at the surface of a polyhedron structure with a top end and a bottom end defined by a frame structure av pipe elements connected to one another at nodes to form polygonal areas constituing the areas at the surface of the polyhedron structure in which the solar panels are mounted. Within the interior of said polyhedron structure, a central buoyancy body is arranged in a manner allowing vertical displacement thereof.

### BACKGROUND

The disclosed embodiments relate to a floating solar energy production device.

The world is in the middle of an energy crisis, where demand for renewable energy is enormous. In this perspective, new inventions for versatile production of solar energy are highly desirable and in particular devices, systems and techniques that allow energy production take place offshore or in a lake, thereby not requiring large onshore areas to be occupied by the energy plants.

The world's oceans represent close to 70% of the earth's surface, of which 99% is unused area, an enormous potential for economic growth linked to energy capture.

Until today, the pioneers in the field of energy capture in the sea have largely used technology and solutions based on heavy steel, concrete and metal. Construction principle and design criteria have followed the principle of standing against the forces of the sea. These conventional solution principles have also been shown to have limitations related to satisfying requirements for sustainability and the environment.

This creates challenges for modern ocean-based construction solutions into a green age, as present solutions are expensive to produce, have a high weight and material use, with long and energy-consuming production, as well as a limited lifespan.-In other words, investments in current technology are significant, where subsequent requirements for a return on invested capital are demanding. The success criterion is defined based on the costs of producing 1 kWh of energy and the lifespan for the power plant.

It has recently been suggested to use solar panels that float on the sea surface, ref. www.oceansun.no/the-innovation, since this is an easy and inexpensive way of arranging and supporting the solar panels in large areas with a comparatively low degree of use or traffic. In this type of floating sun plants, the solar panels are mounted flat at a membrane in a 2-dimensional arrangement, with an exposed area for sun capturing limited to the square of the floating installation.

### SUMMARY

Provided herein is a floating solar energy production device that is lightweight, versatile and well protected against harsh weather conditions.

The disclosed embodiments provide a device which is more space-efficient than existing ones.

When using the word “structure” hereinafter, as separate from the device, the structure is primarily the skeleton of pipe elements and nodes and elements that provide structural integrity to the device.

The term “gas” used herein with regard to the medium supplied to the different buoyancy bodies and elements, may be any non-toxic, non-hazardous gas. In practice, an inert gas like nitrogen or simply ambient air is typically used for the purpose.

The term “bladder” is used is used about buoyancy elements of a flexible nature, not necessarily tube shaped, the volume of which depending on the amount of gas present in such buoyancy elements at any given time.

The disclosed embodiments have ground-breaking technology with new solutions that deliver in line with the foundation of the green shift. The embodiments and the technology represent cost-effective and sustainable solutions for producing renewable energy.

The device disclosed herein is a device for capturing solar energy, in the form of a normally floating, at least partly submersible and flexible construction. The shape of the device may be substantially spherical or egg-shaped (rotational body of an oval), more technically having a shape of a polyhedron, the surface of which defined by a number of hexagonal and pentagonal areas separated by a skeleton of pipe elements of similar or different length(s), interconnected by nodes where the ends of three pipe elements meet. The shape may be truncated, in particular the part typically intended to be below water-level. If a spherical design is intended, the pipe elements will typically all be of same length, if an egg-shaped structure is intended, the pipe elements will typically have different lengths as longer pipe elements tend to reduce the curvature of the structure. Also use of finger brackets with different geometry will tend to change the curvature of the structure. Different curvature of different parts of the structure leads to an oval (egg-)shape rather than a spherical shape.

A plurality or all of the pipe elements contain bladders or hoses arranged to receive varying amounts of gas, typically air, which function to provide stability to the skeleton and buoyancy to the overall structure. The outside of the structure, and more precisely the part (60-70%) of the structure that is normally above the water surface, is covered with panels of solar cells, typically of a type with the physical property of being flexible/bendable to a certain extent.

In this way, the disclosed embodiments utilize an area for solar cells, such as photo voltaic cells or of other principle for capturing energy from rays of the sun, which is more than twice the area of the sphere's cross-section. The construction's shape means that you also get better use of the solar panels by utilizing the reflection of the sunlight from water, due to its 3-dimensional sun exposure,-which makes a significant contribution to the capture of solar energy.

Since the lower part, 30-40% of the surface area of the structure, has little use of being covered with solar panels, this part of the structure does not need to be similar to the structure intended to carry solar panels. However, also the lower part of the structure, and in particular the lower part of the structure, needs to contribute to the required buoyancy. Therefore, the simplest design of the structure is a coherent structure, where the lower part is similar to the upper and middle part of the structure, being comprised by same pipe elements (struts) enveloping hoses arranged to receive varying amounts of gas, even though the polygons defined by the pipe structure is not used for carrying solar panels.

The disclosed device is characterized by low material use and weight, where solutions in many cases are well below 95% of existing steel solutions.

The embodiments provide efficient production with a short delivery time to the market. This is because the embodimetns are based on a few standardized construction elements, with time-efficient assembly, where the structure's pipe elements are connected at nodes without welding or heavy bolts, using sleeves that moves freely in relation to the pipe elements while being firmly attached to the nodes.

The pipe elements envelopes flexible hoses arranged to receive varying amounts of gas to thereby vary the overall buoyancy of the device, and must for that purpose be able to withstand a pressure of at least 3 bars, more preferably at least 8-10 bars.

The presence of such hoses within the pipe elements not only serves the purpose of providing buoyancy, but also serve to provide stiffness to the pipe elements and thereby to the structure as such, allowing the use of comparatively lightweight and thin-walled synthetic materials for the pipe elements, rather than a framework of metal, thereby allowing light-weight, inexpensive materials and low production costs. The pipe materials are typically lightweight synthetic materials, preferably reinforced with glass fibres or carbon fibres or the like, though even thin-walled light-weight metals like aluminium would serve the purpose.

Even the pipe elements will be flexible to a certain extent, in the sense that they may be temporarily curved along their length when exposed to forces but not to an extent in which their general shape, diameter or length, will be substantially influenced.

For the part of the construction that is intended to be above water most of the time, the hoses or bladders within the pipe elements can be, but need not be, permanently pressurized for increased strength, damping and flexibility, and to withstand specified wind forces and waves within specified load intervals. For the part of the construction that is intended to be under water at all times, pressurized hoses within the pipe elements will contribute to the construction's buoyancy, rigidity and to position control of the construction. This is explained in more detail below.

Use of an optional ballast element at the bottom end of the structure will help ensuring that the orientation of the structure in the water is constant, not only decided by its mooring to the sea bottom, and therefore a preferred embodiment.

A centre column extends from the bottom to the top of the structure and contributes to the overall structural integrity of the structure. It also serves as a guide for additional buoyancy bodies, including a buoyancy body glidingly arranged along the centre column to thereby move the centre of gravity for the device and thereby its elevation in the water.

The lower part of the device preferably also comprises a stationary buoyancy body which can be permanently filled with a certain amount of gas to provide a buoyance adapted to the weight of the lower part of the device while considering additional buoyancy provided by the hoses within the pipe elements and the requirement that the lower part should not have a net buoyancy that is more prominent than that of the upper part of the device.

Generally speaking, the buoyancy from the structure's pipe elements, (with buoyancy bodies in at least some of these elements), central buoyancy body, and mooring arrangement keeps the overall structure in the desired position and orientation. The construction's position in the water column is controlled by regulating buoyancy due to changes in volume, controlled by changes in the bladder's gas pressure.

As already mentioned, the pipe elements as such are flexible to a certain extent, while the pipe elements are freely terminated in sleeves and without welded joints. This means that externally applied forces are absorbed by the construction,—like a ball being kicked. In addition, the pipe elements gain increased stiffness and strength when the hoses therein are pressurized. Combination of these factors forms what we define as a dynamic construction.

The bottom or lower part of the device has the function of stabilizing the polyhedron structure in desired positions. The lower part is designed so that, with the help of buoyancy, optionally a winch and arrangements thereto, the device can be positioned at the desired level in the water column, from a submerged position to a position where more than 65% of the device is above the water surface. A rigid frame or plate at the lower part also forms the foundation for the construction's pipe elements as well as a base for the construction's centre column. The lower part may also be equipped with a buoyancy body comprising one or more buoyancy elements which are arranged to be variably pressurized to give the desired buoyancy in different situations. The lower part may also comprise a separate ballast element arranged to stabilize the device.

When a buoyancy body is present in the lower part of the device, it may be arranged as a platform, which can hold desired equipment for positioning, management and control, including monitoring, collection and communication of operational data. Such a platform may also contain a waterproof compartment for housing desired equipment. The lower part is typically rigged to handle the connection of transmission electric cable(s), either to a local consumer, or via cable to connect to the existing electric network, or type of electric grid via cable along a sea bottom.

The upper part of the polyhedron structure has the function of stabilizing the structure in a submerged position, and may include a buoyancy body comprising hoses/bladders which are arranged to be filled with gas to give the desired buoyancy to the structure, in particular in a fully submerged position. The upper part should always have a higher buoyancy than the lower part in order to maintain the orientation of the device with the upper part as the top part. By the term “filled with gas” is understood an amount of gas sufficient to withstand the pressure from the surrounding water when submerged.

In the surface position, the top part of the structure may preferably be arranged as a platform, which can be equipped with the desired equipment for energy capture, positioning, management and control, including collection, monitoring and communication of operational data. Such a platform may also contain a waterproof compartment for equipment for handling collected energy from solar cells, including switch cabinets, control units, inverters and or battery packs.

The upper part can also be used for embarkation with access from a helicopter, crane etc. if required.

The centre column has the function of holding the construction together in a defined shape, where there is a fixed or dynamic connection between the top side and the bottom side. The centre column typically has an internal bore for the passage of various cables, hoses and mooring line arrangements.

Additionally, the centre column is a guide for a central, displaceable buoyancy body, arranged symmetrically around the centre column, ensuring that the structure maintains its desired position in and usually partly above the water masses. The centre column can also have a function as a storage of dynamic splines/stays to remedy the construction's ability to withstand extreme environmental forces. The term “central” indicates that this buoyancy body is arranged generally closer to the centre of the overall structure than other (optional) buoyancy bodies that may also be present in some embodiments.

The design of the centre column may be so designed that it can be included as part of another device, such as a lift or stair for transporting equipment and personnel between different levels within the overall structure.

The central, displaceable buoyancy body arranged symmetrically around the centre column has a.o. the function of stabilizing the polyhedron structure in surface position, so that it resists waves and wind specified for the relevant area of use. The central buoyancy body is designed so that it can be positioned and locked at desired positions along the centre column. The lower the central buoyancy body is positioned along the centre column and the more volume occupied within its buoyancy elements, the higher the device will float in the sea.

The location of the central buoyance body along the centre column also depends on the operational phase the structure is operated within. During installation and/or service situations where a vertical mooring line is not tightened to the bottom, the central buoyancy body and ballast element(s) ensure that the structure maintains an orientation in which the centre column is in an approximately vertical position.

The central buoyancy body is typically designed as a platform, which can be equipped with the desired equipment for positioning, steering and control, including monitoring, collection and communication of operating data. The platform typically also contains one or more waterproof compartments for placing equipment for handling collected energy from solar cells, including switch cabinets, control units, inverters and or battery packs and/or compressors.

Collected energy may be transferred via cable, either to a local consumer, or via cable connected to the existing electricity network, or type of electric grid via cable along the bottom. Collected energy may also be converted into pressurised gas, either to be stored in the construction, or to be transferred via hoses to storage compartments, typically large diameter hoses arranged vertically or horizontally at the bottom of a sea or lake. Stored, pressurised gas can be used for electricity production delivered to the electrical grid when needed.

The platform of the central buoyancy body may also be used for embarkation with access from service vessel.

### Buoyancy and Buoyancy Control

A buoyancy control system is arranged to regulate and control the position of the device in the body of water. Buoyancy is regulated through volume changes in the buoyancy elements using gas supply. When gas is supplied, water is forced out by the individual hoses, bladders and/or other gas compartments. Thereby, the overall buoyancy changes and the construction may be controlled with regard to its degree of submersion in the water mass.

Gas may be supplied from pressurized gas storage reservoirs on the structure, on the sea floor or above the water surface. The buoyancy system is partly arranged in the pipe elements constituting the polyhedron structure, partly in the central buoyancy body and other buoyancy elements arranged within the structure. The division into several compartments also contributes to the safety of the system. Should one compartment experience a leak, the lack of buoyance from that compartment may be compensated by increased buoyancy from other compartments.

Wherever in this document a buoyancy body is discussed, unless otherwise specified, it is understood that the bouncy body may comprise one single buoyancy element or a plurality of buoyancy elements and that each of said elements may have, and typically will have, adjustable buoyancy by adjustable degree of inflation.

The construction uses gravity to sink the construction into the body of water. A winch arrangement may be used to maintain the vertical position of the structure and occasionally, if need be, to pull the entire structure below sea level, accompanied by reducing the gas volumes in the buoyancy compartments. This means that the winch arrangement in its simplest form does not need to be dimensioned to pull the structure down into the bodies of water.

### Solar Panels

The solar panels may be of any commercially available type, preferably of a type exhibiting inherent flexibility, such as the ones described in EP 2 819 176A, EP 3 159 937A or GB 2 428 331. Alternatively, or additionally, the solar panels may be suspended to the polyhedron structure by flexible attachment means.

### Battery

One or more electrical battery may be included as an optional element in order to accumulate energy during the light hours of the day for delivery during dark hours of the day. Such battery may be provided in a water-tight compartment in a position allowing it to be cooled by ambient water.

### BRIEF DESCRIPTION OF THE DRAWINGS

In the following, the invention will be described in more detail in the form of some selected, non-limiting embodiments, with reference to the accompanying drawings.

FIGS. 1A and 1B are schematic side views of structural parts of a device according to an embodiment of the disclosure;

FIG. 2 is a schematic side view of structural parts of a device according to another embodiment, which is slightly different from the embodiment of FIGS. 1A and 1B;

FIG. 3A is a schematic side view of structural parts of a device according to another embodiment, which is slightly different from the embodiments of FIG. 1 (A and B) and FIG. 2;

FIG. 3B is a schematic side view of structural parts of a device according to another embodiment, which is slightly different from the embodiment of FIG. 3A;

FIG. 3C is a schematic side view of an embodiment similar to the embodiment of FIG. 3B, but with a different position in the water.

FIG. 3D is a schematic side view of an embodiment similar to the embodiment of FIG. 3A, differences being related to number, position and shape of buoyancy bodies.

FIGS. 4A-4D illustrate some principles of solar panel attachments;

FIGS. 5A and 5B are illustrations of variants of a detail element of a device according to the disclosure;

FIG. 5C is a sectional view of detail elements of a device according to the disclosure;

FIGS. 5D to 5F are sectional views of detail elements of a device according to the disclosure.

FIG. 6 is a graph illustrating power produced over the hours of a day.

### DETAILED DESCRIPTION

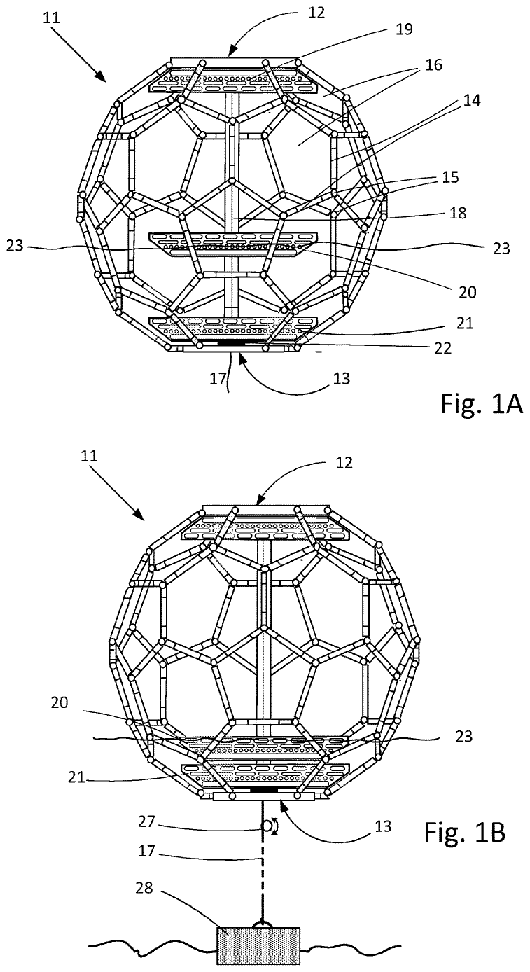

FIG. 1A is a side view of an embodiment of a polyhedron structure 11 constituting the “skeleton” of a device according to the disclosure. The skeleton has a top end 12 and a bottom end 13 and is mainly comprised by pipe elements 14 assembled at nodes 15 in a manner in which each pipe element 14 constitutes a border between two adjacent polygonal areas 16 exhibiting five or six corners. The entire structure is a polyhedron of a mainly spherical shape in spite each polygon basically has a flat surface. Each polygonal area 16 constitutes an area in which solar panels will be mounted in the completed device.

A centre column 18 extends between the bottom end 13 and the top end 12 of the polyhedron structure 11 and has a.o. the function of providing stability to the overall structure that is rather flexible and ball-like without such a stabilizing element. A mooring line 17 is shown attached to the bottom end of the skeleton and may for practical reasons be attached to the lower end of the centre column 18. The mooring line is intended to be attached to a fixed anchoring point, typically a heavy body arranged at the sea bottom, or using any kind of state of the art type of anchoring technology.

FIG. 1A also shows an upper buoyancy body 19, a movable central buoyancy body 20 and a lower buoyancy body 21, the latter being located in the lower half of the polyhedron structure. Each of these three buoyancy bodies comprises at least one buoyancy element but typically a plurality of buoyancy elements as indicated by FIG. 1A, each of which may have different size and shape, ensuring that an adequate buoyancy may be achieved even if one or more elements for any reason should fail.

For stability considerations, the three buoyance bodies typically have generally symmetrical orientation around the centre column, such as horizontal cross-sections in the form of symmetrical polygons or perfect circles. The outer shell or carcass of each buoyancy body is perforated so that water will enter the part of the bodies not occupied by any buoyancy element at any given time. Also, for stability considerations, the bottom end 13 of the polyhedron structure may be provided with a ballast element 22 of moderate weight that serves to make the bottom end of the polyhedron structure heavier than the upper end, thereby ensuring that the bottom end 13 remains the bottom end also if there is a slack on the mooring line 17. Such ballast element may also be positioned outside the skeleton structure of the device, e.g. attached to the mooring line 17. Although not shown in FIG. 1A, also the pipe elements 14, or at least some of the pipe elements 14 contain buoyancy elements that serves the dual function of providing buoyancy and providing rigidity to the overall polyhedron structure. The latter feature allows the pipe elements to be manufactured in rather lightweight materials, such as synthetic and/or composite materials and also to use non-rigid connections at the nodes where three and three pipe elements are connected.

As indicated by FIG. 1A, the water line 23 of the sea in which the structure floats may typically pass at a level at which the movable central buoyancy body 20 resides. The central buoyancy body 20 may be positioned at different levels along the centre column 18.

A person skilled in the art will understand that the upper buoyancy body 19 does not contribute to the buoyancy when it is above water. It will contribute to buoyancy when the structure is almost entirely submerged in water and naturally when or if the entire structure is pulled down under water by a winch on the mooring line, which may be desired under heavy weather conditions, to avoid damage to the device. Although not shown in FIG. 1A, the upper buoyancy body 19 may therefore have more modest dimensions than buoyancy bodies 20 and 21.

FIG. 1B shows the polyhedron structure 11 from FIG. 1A in a position higher in the water, i.e. less submerged, than the case of FIG. 1A. This position is obtained by lowering the central buoyancy body 20 to a position adjacent to the lower buoyancy body 21. This position has the advantage of exposing even more of the surface to the sun, thereby producing more energy, provided that the forces of wind are not too strong to allow this more exposed position. It may also be required in order to obtain this position to fill additional gas into the buoyancy elements of the central 20 and/or the lower buoyancy body 21.

FIG. 1B also shows the mooring line 17 attached to an anchoring device 28 in the form of a bottom block via a winch 27 that is able shorten the free length of the mooring line until the entire structure is submersed under water. This feature may be included in any embodiments and variants disclosed herein. The winch 27 and the anchoring device 28 are optional elements of the disclosed embodiments. In order to prevent undesired rotation around a vertical axis of the inventive device, more than one mooring line may be attached at the lower end of the device and attached to a plurality of anchoring devices, typically two or three, spaced apart at the sea floor.

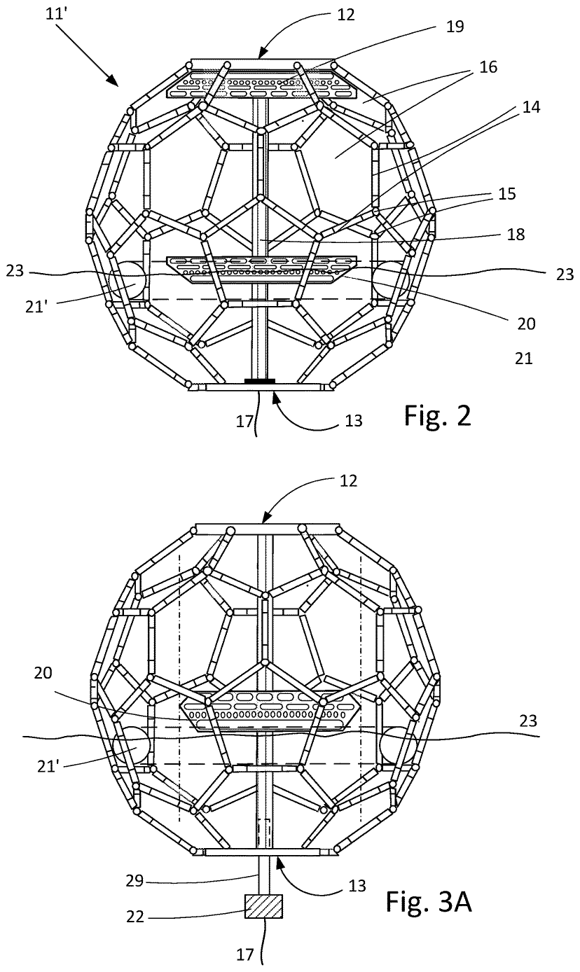

FIG. 2 illustrates an embodiment slightly different from the embodiment shown in FIGS. 1A and 1B, the difference being that the lower buoyancy body 21′ has the shape of a ring arranged at the periphery of the polyhedron structure at the level where the water line is intended to be when about 60-70% of the surface of the polyhedron structure is above the water surface, producing energy. It may be beneficial from a stability point of view, not to apply excessive buoyancy at the lowermost point of the structure and to provide buoyancy distributed near the periphery of the overall structure. The displaceable central buoyancy body 20 may be moved all the way down to the lowermost point inside the polyhedron structure when so desired or required. The ring shaped lower buoyancy body 21 would typically be arranged to hold varying amounts of gas, thus able to provide adjustable buoyancy in the same manner as the other buoyancy bodies.

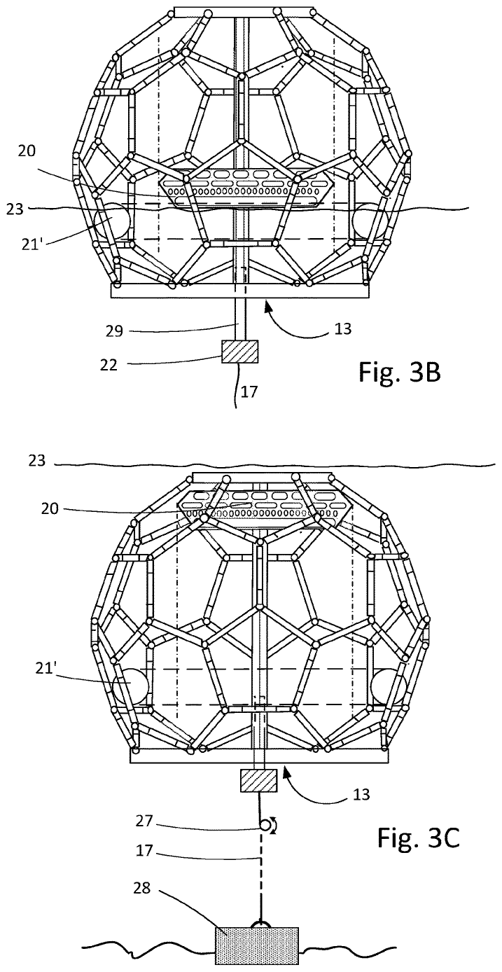

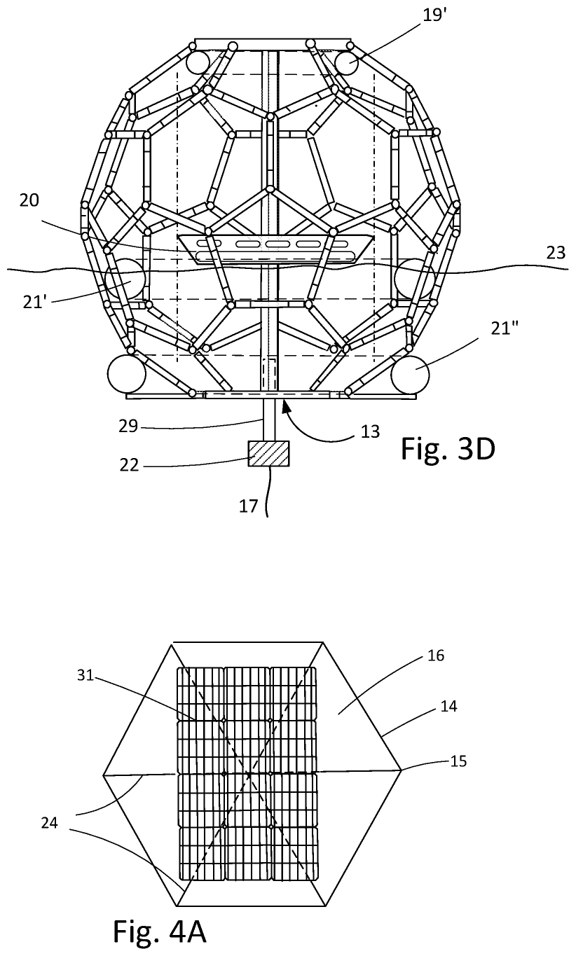

FIG. 3A shows an embodiment with one central, displaceable buoyancy body 20 arranged symmetrically around the centre column, and a ring-shaped lower buoyancy body 21′ similar to the one shown in FIG. 2. The difference from the embodiment of FIG. 2 is that there is no upper buoyancy body present, instead the central, displaceable buoyancy body 20 is free to move all the way from top to bottom within the polyhedron (skeleton) structure.

As with the previous embodiments, when the central buoyancy body 20 is moved to a low position within the skeleton structure, the structure will move to an elevated position in the surrounding water and when the central buoyancy body 20 is moved to a high position within the structure, it will move to a comparatively low position in the surrounding water.

FIG. 3A also shows a ballast element 22 attached to a rod 29 arranged in an extendable manner within the lower part of the centre column 18. This feature may also be included in other embodiments disclosed herein, included the ones illustrated by FIGS. 1A, 1B and 2.

FIG. 3B is a schematic side view of structural parts of a device according to an embodiment, which is slightly different from the embodiment of FIG. 3A. The difference from the embodiment shown in FIG. 3A is that the structural part has a truncated lower part, i.e. the part that will typically be below the water surface and which is not intended to carry solar capturing panels.

FIG. 3C is an illustration of an embodiment similar to the embodiment shown in FIG. 3B with the exception of its vertical position in the water. FIG. 3C shows the device fully submerged in the water and the central buoyancy body 20 run all the way to the top. In order to achieve this position, it is natural to shorten the mooring line 17 by means of the winch 27 and/or to reduce the air volume in the central buoyancy body 20 and optionally in other buoyancy elements. Running the central buoyancy body all the way to the top is not a mandatory measure, but will reduce the period in which the winch needs to counteract the buoyancy caused by the central buoyance body in the process of lowering the device. All shown embodiments of the device disclosed herein may be submerged in the manner illustrated by FIG. 3C.

FIG. 3D is an is an illustration of an embodiment similar to the embodiment shown in FIG. 3A with a few exceptions explained below. One exception or difference is the presence of an upper buoyancy body 19′ in the form of an annular body more or less similar to the lower annular body 21′ of FIGS. 2 and 3A instead of the upper buoyancy body 19 of FIG. 1. The annular type buoyancy body saves weight and increases the stability of the overall device. This also allows a slimmer version of the central buoyancy body 20, as depicted in FIGS. 1A, 1B, and 2 rather than the more voluminous one shown in FIG. 3A.

Last, but certainly not least, FIG. 3D shows the presence of an additional, auxiliary buoyancy body 21″, arranged at the lower end of the polyhedron structure. By auxiliary in this context is understood that it is arranged outside the confine of the polyhedron structure to further increase the stability to the overall device which is particularly important when more than 50% of its surface is positioned above water, which is typically the case under normal operating conditions. It may also serve as a fender, protecting the structure against damage caused by external forces, such a contact with boats approaching the device. The auxiliary buoyancy body 21″ can also be inflated to a degree by which it is mostly or entirely submerged and not influenced by waves, allowing waves to pass more or less unhindered through the polyhedron structure.

Like other buoyancy bodies, also the auxiliary buoyancy body 21″ may comprise more than one buoyancy element and may be adjustable with regard to its inflation and thereby its degree of buoyancy.

Generally, the operation and degree of inflation of all inflatable buoyancy bodies may be controlled at all times and will depend upon phase of operation, weather condition, the desired position of the device in relation to the water line, etc. and will be manually and/or automatically controlled.

Generally speaking, any winching in of the mooring line could benefit from reduced buoyancy and any winching out of the mooring line could benefit from increased buoyancy. This can be achieved manually or controlled by a control unit, which per se is not part of the invention disclosed herein. Such a control unit could beneficially also serve the purpose of controlling that the upper part of the device at any point in time has a lower density than the lower part, thereby ensuring that the structure does not turn over.

The winch should be designed and dimensioned to handle the net weight of the overall structure. By net weight in this connection is understood the “balance” between weight and buoyancy in water. It is a prerequisite that the winch is able to pull the entire structure under water, at least in combination with an effective reduction of gas (air) in the buoyancy elements.

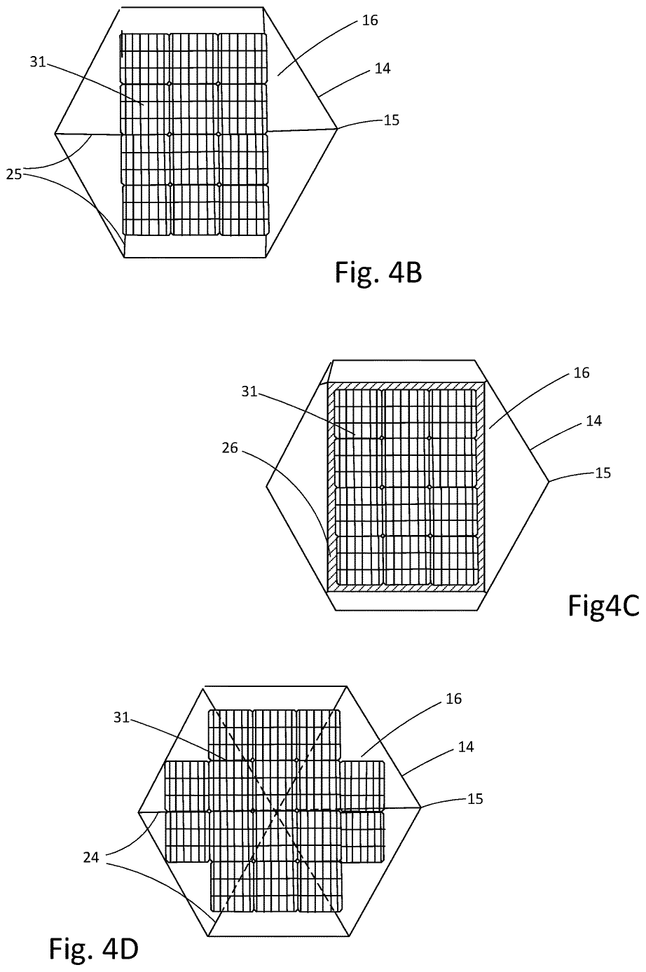

FIG. 4A shows a principle for attachment of an array of solar panels 31 to a hexagonal area 16 in the polyhedron structure of the device. The attachment means is constituted by a number of elastic strings 24 arranged in a criss-cross pattern beneath the solar panels 31.

FIG. 4B shows an arrangement rather similar to that of FIG. 4A, the difference being that the elastic strings 25 are just attached to the array of solar panels 31, but do not run across the polygonal area 16 and do not therefore support the backside of the solar panels.

FIG. 4C shows a variant that differs from 4A and 4B in that the array of solar panels 31 is supported by a flexible sheet 26, typically of a light-weight, synthetic material having a flexibility about similar to, or slightly less flexible than, the (array of) solar panels.

FIG. 4D illustrates solar panels attached in the same manner as shown in FIG. 4A, the difference being that the array of solar panels used has a shape different from a rectangular shape in order to cover more of the available area within the hexagon shaped area 16.

For the purpose of efficiency, as much as possible of the available areas should be used for solar panels in industrial applications, just leaving free space to allow air and water the possibility of swiftly passing from the inside to the outside of the polyhedron structure and vice versa, when the structure moves vertically in an ambient water mass. While solar panels are shown for just one hexagonal space above, it is emphasized that most of, or all of, the hexagonal and pentagonal spaces be furnished with solar panels in industrial versions of the device.

Attachment of solar panels within pentagonal spaces of the polyhedron structure 11 may be accomplished using the exact same principles as described above.

While solar panels of flexible nature are preferred, also rigid solar panels may be used.

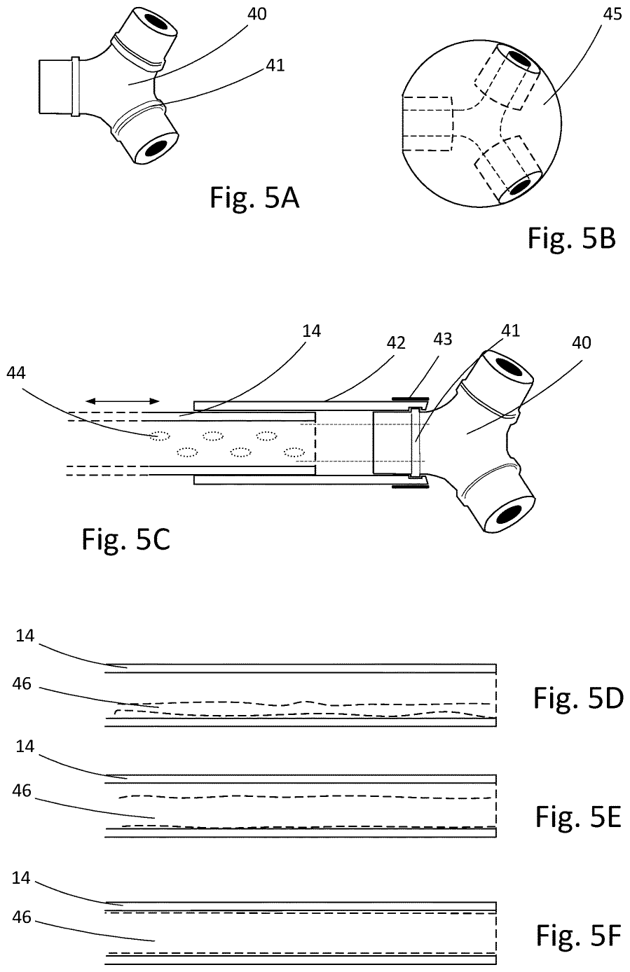

FIG. 5A shows a three-finger finger bracket 40 used to form nodes between the pipe elements of the polyhedron structure disclosed herein. The finger bracket typically has a slight angular change between each finger so that if you place an imaginary plane through the centre of two of the fingers, the third finger will be outside the plane. This contributes to the curvature of the surface formed by assembling a polyhedron structure, so that a mainly spherical surface can be obtained without applying any bending force to the pipe elements 14 between the finger brackets. FIG. 5A shows the finger bracket 40 from its concave side, i.e. the side which in mounted condition will face the inside of the polyhedron structure. Each finger on the bracket is equipped with a fastening device such as an annular flange 41 suitable for locking an adapted sleeve.

FIG. 5B shows a finger bracket 45 with an interior corresponding to the finger bracket shown in FIG. 5A, but with an outer shape which is substantially spherical. It works in the same way as the finger bracket 40, but the attachment to the sleeve can be done in another way, for example with an external bayonet attachment or screw threads.

FIG. 5C shows a (partial) section through a pipe element 14 which is connected to a finger bracket 40 by means of a sleeve 42. The sleeve 42 is fixedly attached to the finger bracket 40 by the flange 41, optionally secured with a tension-band 43, while the pipe element 14 can slide back and forth inside the sleeve 42 depending on external influences on the polyhedron structure, such as wind and waves.

The sleeve 42 is of such a length that the pipe element 14 cannot slide completely out of the sleeve even under severe stress. In addition, the centre column 18 stabilized the overall structure of the polyhedron, thereby also contributing to the same purpose of stability despite flexibility.

The pipe elements 14 will typically exhibit perforations 44 to allow water to flow into and out of the part of the pipe elements not occupied by hoses or bladders filled with gas. Water will also to some extent be able to enter the pipe elements at their connections to the sleeves 42.

As evident from the explanation above, the assembly can take place without the use of welding, bolts, threads or screwing.

While not illustrated by FIGS. 5A-5C, the passages through the finger brackets 40 which constitute the physical element of a preferred embodiment of the nodes 15, are typically used for transfer of gas used to adjust buoyancy of different buoyancy elements of the device, and also for transferring electric signals for control and surveillance of any part, element, sensor, etc. that require electric signals for their operation.

FIG. 5D shows part of a pipe element 14 with a hose 46 therein, the hose barely filled with gas in the shown condition. For simplicity, perforations are omitted in this drawing.

FIG. 5E shows same pipe element 14 as FIG. 5d but with some amount of gas filled into the hose 46. FIG. 5F shows same pipe element 14 as FIGS. 5d and 5e with the hose 46 filled with sufficient amount of gas to make the hose fill the entire volume of the pipe element 14. A person skilled in the art will understand that the pressure required to hold the hose 46 fully expanded within the pipe depends on the depth at which the pipe is positioned beneath the water surface, the surrounding water pressure increasing by about 1 atm per 10 meters of depth.

All the features mentioned above in relation to all FIGS. 1-5 are combinable with one another unless mutually excluding by their inherent nature.

In addition to the buoyancy elements described above, the disclosed device may include any number of non-adjustable buoyancy elements contributing to the overall buoyancy of the device.

The device may include any number of water-tight compartments for storage and safeguarding of equipment and personnel. Such compartments may be included in the central buoyancy body and also in optional buoyancy bodies when present. When included, the control unit for controlling operational parameters, filling and emptying of buoyance elements, starting and stopping of the winch etc., and also any other related electronic equipment, generally referred to as technical equipment, may be arranged in water-tight and protected compartments.

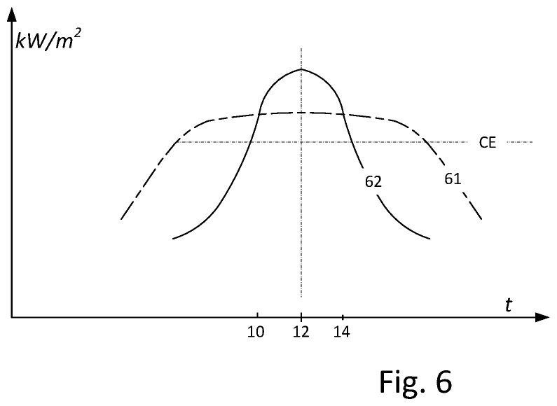

FIG. 6 is a schematic diagram illustrating the power production of a demo production plant through one day compared with similar data for a plant having solar panels resting flat on a water surface. The kW effect per m² area of solar panels is shown as graph 61. Graph 61 has a rather flat plateau that extends for several hours over a threshold value CE representing a cost/efficiency level considered profitable at given circumstances. In comparison, the standard arrangement of solar panels resting flat on a water surface, curve 62, shows a higher peek at the time the sun is at its highest, but falls off much more abrupt and therefore produces energy above the profitable threshold value for a much shorter period of time each day.

The device may include an arrangement for direct or indirect cooling of the solar panels. Direct cooling may be performed by spraying water onto the solar panels, preferably to their back sides. Indirect cooling may be provided by supporting the solar panels on hollow support structures arranged to have coolant water flowing therethrough.

In its simplicity, the disclosed embodiments play with the sea. The solution is designed to handle defined environmental factors in a normal situation, while the embodiments open up the possibility that the device can be submersed in periods of extreme conditions in the form of wind, waves or temperature.

The disclosed embodiments allow energy production—or energy capture—in near-coast sea areas. These are sea areas which until now have been unsuitable for sustainable capture of solar energy. Until now, this unsuitability has been assessed from a cost perspective, where existing technology and solutions are either very expensive and require significant investment, or that the existing solution is not compatible with large waves and wind.

The disclosed embodiments exhibit a structural shape which is unique in its construction and which solves the mentioned challenges, among other things in that it can be immersed completely under water which is a great advantage in bad weather.

Furthermore, the submersible function of the device enables the installation of coastal energy capture plants where conventional systems are unable to withstand the strong natural forces to which the facilities are occasionally exposed.

The submersion ability of the embodiments also offers advantages in rearing in that upper water masses can be avoided in critical situations, such as in the case of oil spills caused by discharges from the oil industry or accidents at sea or in war type situations.

Sizing of the polyhedron structure with respect to its diameter can be done by selecting pipe elements with different lengths and/or by changing the geometry of the finger brackets so that the curvature generally becomes smaller or larger at each node.

1-18. (canceled)

19. A floating solar energy production device, comprising
a frame structure with a top end (12) and a bottom end (13) formed by pipe elements (14) connected to one another at nodes (15) to form polygonal areas (16) for mounting solar panels;
a plurality of connected solar panels (31) arranged and mounted at the polygonal areas (16) to form a surface of a polyhedron structure (11), wherein
the polyhedron structure (11) defines an interior, and
a central buoyancy body (20) is arranged within the interior in a manner allowing vertical displacement thereof.

20. The device according to claim 19, further comprising a center column (18) extending from the top end (12) to the bottom end (13) of said polyhedron structure (11).

21. The device according to claim 20, wherein the central buoyancy body (20) is arranged symmetrically around the centre column (18).

22. The device according to claim 21, wherein the central buoyancy body (20) comprises one or more flexible bladders configured to be filled with varying amounts of gas to provide varying buoyancy.

23. The device according to claim 19, wherein the central buoyancy body (20) comprises one or more flexible bladders configured to be filled with varying amounts of gas to provide varying buoyancy.

24. The device according to claim 19, further comprising a lower buoyancy body (21, 21′) positioned within a lower half of said polyhedron structure (11).

25. The device according to claim 19, further comprising an upper buoyancy body (19, 19′) positioned at the upper end of said polyhedron structure (11).

26. The device according to claim 19, further comprising an auxiliary buoyancy body (21″) positioned at the lower end and external of said polyhedron structure (11).

27. The device according to claim 19, further comprising a ballast element (22) positioned at or beneath the bottom end (13) of the polyhedron structure, arranged to be moored to an anchoring device (28) at a sea or lake bottom or both.

28. The device according to claim 19, wherein
the pipe elements (14) defining the polyhedron structure are inherently flexible, and
at least some of the pipe elements (14) envelope flexible gas-tight pressure resistant hoses (46) that are configured to be filled with varying amounts of gas.

29. The device according to claim 21, wherein
the pipe elements (14) defining the polyhedron structure are inherently flexible, and
at least some of the pipe elements (14) envelope flexible gas-tight pressure resistant hoses (46) that are configured to be filled with varying amounts of gas.

30. The device according to claim 19, wherein the pipe elements (14) are connected at the nodes (15) via finger brackets (40) and sleeves (42) providing flexible connections.

31. The device according to claim 19, wherein the polyhedron structure (11) has a shape that selected from the group consisting of spherical, rotational ovular, truncated spherical, and truncated ovular.

32. The device according to claim 19, wherein the pipe elements (14) are assembled to form polygons having a combination of five and six sides.

33. The device according to claim 19, wherein
the central buoyancy body (20) is configured to receive a gas, and
the gas to be supplied to the central buoyancy body (20) is arranged to be pumped or filled from at least one pressurized gas reservoir arranged subsea or above the sea surface.

34. The device according to claim 19, wherein the solar panels (31) exhibit inherently flexible properties.

35. The device according to claim 19, wherein the solar panels (31) are attached to the pipe elements (14) via flexible attachments selected from elastic strings (24), spring tensioned attachment means, and combinations thereof.

36. The device according to claim 19, further comprising a mooring line (17) extending from the bottom end (13) of the polyhedron structure (11) to an anchoring device at the sea floor.

37. The device according to claim 19, further comprising an arrangement for direct or indirect cooling of the solar panels.

38. The device according to claim 19, wherein the central buoyancy body (20) comprises at least one water-tight compartment configured to house technical equipment, personnel, or both.
